(19) United States
(12) Patent Application Publication
(10) Pub. No.: US 2011/0163569 A1
(43) Pub. Date: Jul. 7, 2011

(54) TERMINAL MOUNTING STRUCTURE AND METHOD

(76) Inventors: Miki Yoneyama, Tokyo (JP); Kohichiro Kawate, Tokyo (JP); Kenji Kuwahara, Tokyo Pref (JP)

(21) Appl. No.: 13/063,843

(22) PCT Filed: Jan. 23, 2009
(86) PCT No.: PCT/US09/31879

§ 371 Date: Mar. 14, 2011

(30) Foreign Application Priority Data
Sep. 16, 2008 (JP) 2008-236868

(51) Int. Cl. B60J 1/00; H01R 4/00; B29C 65/48

(52) U.S. Cl. 296/146.1; 439/733.1; 156/297

(57) ABSTRACT

To provide a terminal mounting structure, the electrical continuation and the joining strength of which are sufficiently high although the structure is simple, further the reliability of which is high even when it is used over a long period of time and to provide a terminal mounting method therefor. A terminal (3) is connected and continued to a conductor (2) such as a heating wire provided on a substrate (1). Terminal (3) includes: a fixing portion (31); elastic portions (32) extending from fixing portion (31); and a substrate contact portion (33) provided in elastic portion (32) so that substrate contact portion (33) can be protruded with respect to substrate (1), and electrically connected to conductor (2). Each fixing portion (31) is made to adhere to substrate (1) by a joining means such as a double-sided adhesive tape (4). Substrate contact portion (33) of terminal (3) is made to adhere to substrate (1) by adhesive (5) under the condition that substrate contact portion (33) comes into contact with conductor (2) by a repulsive force generated by an elastic displacement of elastic portion (32).

### TECHNICAL FIELD

The present invention relates to a terminal mounting method by which a terminal is electrically connected to a substrate. The present invention also relates to a terminal mounting structure to be applied to the terminal mounting method.

### BACKGROUND

Concerning the method or the structure of electrically connecting a terminal to a conductor such as a heating wire formed on a plane or a curved face such as a rear window of an automobile, various methods and structures have already been known. For example, Japanese Unexamined Patent Publication No. 2007-18981 describes as follows. “A terminal forward end portion 2a and an elastic member 6 are surrounded by a resin material 7. The resin material 7 is attached being made to adhere to a bus bar 4 through an adhesive member 8 located in the periphery of the terminal forward end portion 2a.”

Japanese Unexamined Patent Publication No. 2001-230616 describes as follows. “A conductive silicon rubber member is electrically connected to a forward end portion of a stay portion 6. This conductive silicon rubber member is pressed to an electric power supply pattern portion 3 by an elastic force of the stay portion 6 so that an electrical continuation can be attained.”

Further, Japanese Unexamined Patent Publication No. 2006-294410 describes as follows. “Spring contacts 28 are respectively extended from sides of a frame 27 which are opposed to each other. As clearly shown in FIG. 3, the spring contacts 28 are respectively inclined in directions in which they cross each other. Each forward end portion is bent into an arcuate shape. The protruding portion 29 comes into contact with an electrode 87 provided in a conductor of a glass antenna or a film antenna so that an electrical continuation can be attained.” Further, Japanese Unexamined Patent Publication No. 2006-294410 describes as follows. “At the time of adhesion, an output electrode 26 does not affect a socket housing 20 and a face to be made to adhere, that is, an output electrode 26 does not obstruct an adhesion. Therefore, in an unstable period of time before an adhesive layer 65 is cured and a sufficiently high adhesive strength is generated, a peeling force of peeling the socket housing 20 from the face to be made to adhere and a force of causing a positional displacement do not act. Accordingly, an adhesion can be positively executed.”

It is conventional that a terminal is brazed to a conductor such as a heating wire provided on a substrate. However, it has been desired to develop a technique by which an electrical connection can be positively accomplished at a room temperature without requiring a skill as compared with a brazing work. In the viewpoint of positively attaining an electrical connection, it is possible to employ a method of screwing or joining with pressure in which a substrate is interposed and given pressure. However, in order to execute the above method, it is necessary to make a hole on the substrate or to provide a means for interposing the substrate. In any case, the structure of attaining the electrical continuation and connection deteriorates the flatness on the substrate.

On the other hand, the following electrical connection means is well known. Conductive particles are added into a thermo-plastic adhesive or a thermo-setting adhesive such as an anisotropic adhesive. Therefore, the conductive particles are interposed between bodies to be joined at the time of joining by heat, so that an electrical connection can be made. As compared with a case of brazing or welding in which temperatures not lower than 200° C. are usually required, it is possible to lower a temperature in the electrical joining step in this case. However, it is necessary to raise a temperature to 150° C. or more.

Further, the following means is well known. A conductive rubber sheet, in which conductive electrodes are provided, are interposed between bodies to be joined so that an electrical continuation and connection can be attained. This means is advantageous in that processing can be executed at a room temperature. However, it is necessary to provide a means for giving a compression force to the rubber sheet. Therefore, a space, in which the connecting portion is arranged, is extended larger than that in the case of brazing.

### SUMMARY

An object of at least one embodiment of the present invention is to provide a terminal mounting structure, the electrical continuation and the joining strength of which are sufficiently high although the structure is simple, further the reliability of which is high even when it is used over a long period of time. It is another object of at least one embodiment of the present invention to provide a terminal mounting method therefor.

In order to accomplish the above object, one embodiment of the present invention provides a terminal mounting structure for mounting a terminal on a substrate, on the surface of which a conductor is provided, the terminal including: a fixing portion made to adhere to the substrate; an elastic portion extending from the fixing portion; and a substrate contact portion provided in the elastic portion distant from the fixing portion and electrically connected to the conductor on the substrate, wherein the fixing portion of the terminal is attached to the substrate by a joining means, and the substrate contact portion of the terminal is made to adhere to the substrate by adhesive under the condition that the substrate contact portion of the terminal comes into contact with the conductor by the repulsive force generated by an elastic displacement of the elastic portion.

Another embodiment of the present invention provides a terminal mounting method comprising: a step of forming a conductor on a surface of a substrate; a step of arranging a terminal on the substrate, the terminal having a fixing portion, an elastic portion extending from the fixing portion and a substrate contact portion provided in a portion of the elastic portion distant from the fixing portion and electrically connected to the conductor on the substrate; a step of attaching the fixing portion of the terminal to the substrate by a joining means; and a step of making the substrate contact portion of the terminal adhere to the substrate by adhesive under the condition that the substrate contact portion comes into contact with the conductor by the repulsive force generated by an elastic displacement of the elastic portion.

Still another embodiment of the present invention provides a terminal mounting structure for mounting a terminal on a substrate, on the surface of which a conductor is provided, the terminal includes: a fixing portion made to adhere to the substrate; an elastic portion extending from the fixing portion; and a substrate contact portion provided in the elastic portion, as a free end, distant from the fixing portion and electrically connected to the conductor on the substrate, wherein the fixing portion of the terminal is attached to the substrate by a joining means, and the fixing portion of the terminal is made to adhere to the substrate by adhesive under the condition that the substrate contact portion of the terminal is brought into contact with the conductor by the elastic displacement of the elastic portion.

Still another embodiment of the present invention provides a terminal mounting method comprising the steps of: forming a conductor on a surface of a substrate; arranging a terminal on the substrate, the terminal having a fixing portion, an elastic portion extending from the fixing portion and a substrate contact portion provided in a portion of the elastic portion, as a free end, distant from the fixing portion and electrically connected to the conductor on the substrate; attaching the fixing portion of the terminal to the substrate by a joining means; and making the fixing portion of the terminal adhere to the substrate by adhesive under the condition that the substrate contact portion comes into contact with the conductor by the repulsive force generated by an elastic displacement of the elastic portion.

According to one embodiment of the present invention, the substrate contact portion can be attached to the conductor by adhesive under the condition that the substrate contact portion of the terminal comes into contact with the conductor on the substrate by an elastic force. Therefore, it is possible to obtain a stable connecting state over a long period of time by a simple procedure.

According to still another embodiment of the invention, the fixing portion can be attached to the conductor by adhesive under the condition that the substrate contact portion of the terminal comes into contact with the conductor on the substrate by an elastic force. Therefore, it is possible to obtain a stable connecting state over a long period of time by a simple procedure. Further, the substrate contact portion may slide on the conductor on the substrate, and therefore, the terminal mounting structure may flexibly accommodate to the change in dimension of the terminal due to the thermal expansion or the like.

### BRIEF DESCRIPTION OF THE DRAWINGS

FIG. 1 is a perspective view showing an outline of a first embodiment of the terminal mounting structure of the present invention.

FIG. 2(a) is a view for explaining a method of attaching a terminal, wherein this view shows a state in which the terminal is prepared above a substrate. FIG. 2(b) is a view showing a state in which the terminal is joined to the substrate by using a double-sided adhesive tape. FIG. 2(c) is a view showing a state in which a substrate contact portion of the terminal is contacted with a conductor and fixed by using liquid resin.

FIG. 3(a) is a plan view showing an outline of a terminal of a second embodiment of the present invention. FIG. 3(b) is a view showing a variation of the terminal. FIG. 3(c) is a sectional view taken on line III-III in FIG. 3(b).

FIG. 4 is a perspective view showing an outline of the terminal mounting structure of a third embodiment of the present invention.

FIG. 5 is a perspective view showing an outline of the terminal mounting structure of a fourth embodiment of the present invention.

FIG. 6(a) is a view similar to FIG. 5, showing the state that the adhesive is arranged over the terminal. FIG. 6(b) is a view similar to FIG. 5, showing the state that the adhesive is arranged on substrate contact portion.

FIG. 7 is a view showing a modification of FIG. 5.

FIG. 7(a) is a view an alternate embodiment of the terminal shown in FIG. 7.

FIG. 8 is a perspective view showing an outline of the terminal mounting structure of a fifth embodiment of the present invention.

FIG. 9(a) is a view similar to FIG. 8, showing the state that the adhesive is arranged over the terminal. FIG. 9(b) is a view similar to FIG. 8, showing the state that the adhesive is arranged on substrate contact portion.

FIG. 10 is a view showing a modification of FIG. 8.

FIG. 10(a) is a view an alternate embodiment of the terminal shown in FIG. 10.

FIG. 11 is a view showing a state of the terminal of an embodiment of the present invention before the substrate contact portion is formed.

FIG. 12 is a view showing an outline of the shape of a metallic die for forming the terminal of an embodiment of the present invention.

FIG. 13 is a view showing a state in which the terminal of an embodiment of the present invention is attached to a copper plate.

### DETAILED DESCRIPTION

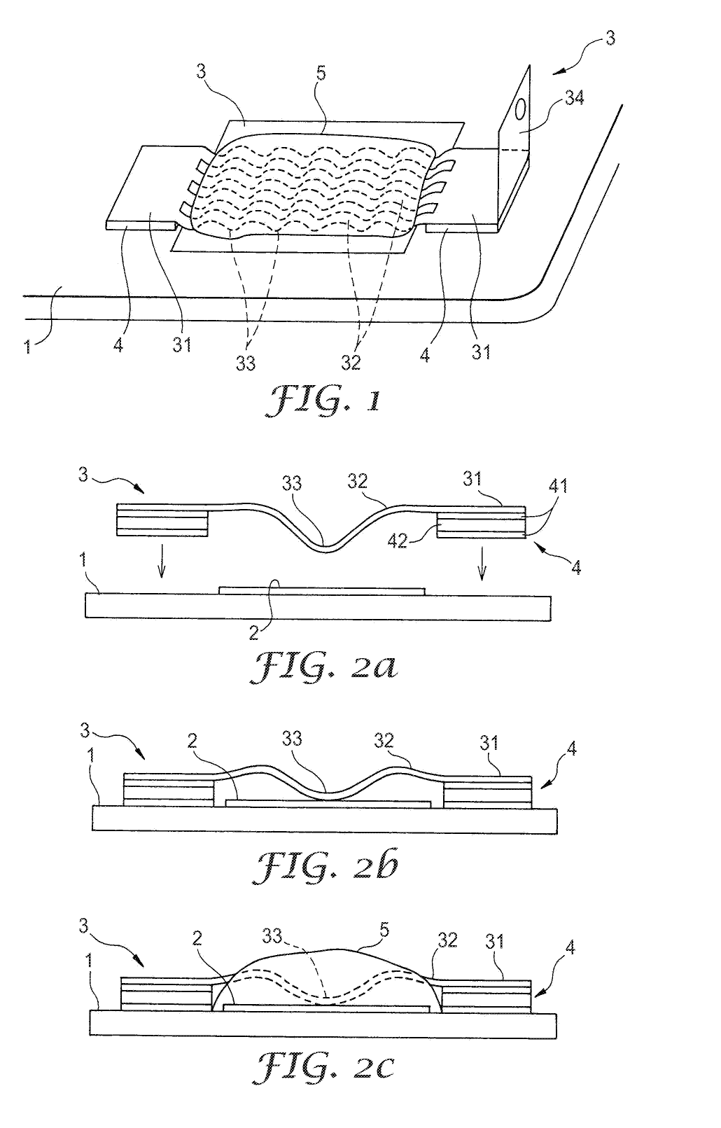

FIG. 1 is a perspective view showing a first embodiment of the terminal mounting structure of the present invention. As shown in the drawing, a terminal 3 is connected and continued to a conductor 2 such as a heating wire which is formed on a substrate 1 such as a rear window of an automobile. Terminal 3 includes: two fixing portions 31; a plurality of elastic portions 32 extending from one of the two fixing portions to the other; and substrate contact portions 33 provided in elastic portions 32 so that substrate contact portions 33 can be protruded with respect to substrate 1, and electrically connected to conductor 2. Each fixing portion 31 is formed into a substantially flat plate shape and a surface of fixing portion 31 on the substrate side is made to adhere to substrate 1 by a joining means such as a double-sided adhesive tape 4. Substrate contact portion 33 of terminal 3 is made to adhere to substrate 1 by adhesive 5 under the condition that substrate contact portion 33 comes into contact with conductor 2 by the repulsive force generated by an elastic displacement of elastic portion 32. In this connection, terminal 3 includes a cable connecting portion 34 to be connected to a power supply cable not shown. Cable connecting portion 34 is arranged being vertically extended from one end of fixing portion 31 in a direction in which cable connecting portion 34 is separate from substrate 1. A connector (not shown) attached to the power supply cable can be connected to cable connecting portion 34. When necessary, a housing (not shown) made of resin may be attached to cable connecting portion 34. An electric current sent from the power supply cable can flow from cable connecting portion 34 of terminal 3 to conductor 2 on substrate 1 through substrate contact portion 33.

FIGS. 2(a) to (c) are views for explaining a method of attaching terminal 3 shown in FIG. 1 to the substrate. In this connection, in order to clarify the explanation, the structure of the terminal is shown in the drawing on the assumption that elastic portion 32 of terminal 3 has only one substrate contact portion. First of all, as shown in FIG. 2(a), substrate contact portion 33, the shape of which is formed into a protruding shape, is arranged in fixing portions 31 in such a manner that substrate contact portion 33 is directed toward conductor 2 side. Elastic portion 32 may be extended in parallel with fixing portion 31. Alternatively, elastic portion 32 may be extended being inclined toward the substrate 1. At this time, the double-sided adhesive tape 4 is attached to or stuck on each fixing portion 31. Alternatively, the double-sided adhesive tape may be stuck on the substrate 1.

Next, as shown in FIG. 2(b), terminal 3 is attached to substrate 1 so that substrate contact portion 33 can be contacted with conductor 2. When elastic portion 32 of terminal 3 is elastically deformed, substrate contact portion 33 is pressed to conductor 2 by the repulsive force of elastic portion 32, so that a reliable electrical continuation can be attained. In this case, as shown in the drawing, concerning the double-sided adhesive tape, it is advantageous to use a tape of the three-layer-structure such as a joining tape Y4920 for VHB (registered trade mark) acrylic form structure to be obtained from Sumitomo 3M Co., Ltd. Concerning the double-sided adhesive tape described above, a base material 42, which is provided between two adhesive layers 41, 41, has elasticity. Therefore, elastic base material 42 has a function of absorbing a shearing stress acting in the direction along the surface of the tape and also absorbing a dimensional change generated by a thermal expansion of the terminal. Accordingly, it is possible to prevent fixing portion 31 of terminal 3 from being easily disconnected from the substrate by an external force given to fixing portion 31 in the direction along the surface of the substrate.

Next, as shown in FIG. 2(c), liquid resin 5 is poured so that substrate contact portion 33 of terminal 3 can be embedded in resin 5 and then resin 5 is cured. In this way, sealing is made under the condition that substrate contact portion 33 is contacted with conductor 2. In this connection, various liquid resins 5 can be used in this case. However, it is desirable to use resin in which a chemical cross-linking reaction is caused and a precise three-dimensional network is formed. Examples of the resin described above are: epoxy resin, photo-curable type acrylic resin, thermo-setting type acrylic resin, unsaturated polyester resin, silicon resin, urethane resin, bismaleimide, cyanoacrylate and urea-formaldehyde resin, which are room-temperature-setting-type resins or thermo-setting-type resins. In this case, when a room-temperature-setting-type resin such as epoxy resin is used, it is possible to execute working at a room temperature without heating. Therefore, each component is not affected by heat. Alternatively, it is possible to use ultraviolet-setting-resin. Further, it is possible to use other thermo-setting resins. However, resin is used, the fusing point of which is lower than 200° C. that is a temperature needed for brazing. It is preferable to use resin, the fusing point of which is not more than 150° C.

In the terminal mounting structure of the present invention, terminal 3 is fixed to substrate 1 by double-sided adhesive tape 4 and substrate contact portion 33 is pressed to conductor 2 by an elastic force of elastic portion 32. In this state, substrate contact portion 33 of terminal 3, which is an electrical contact portion of terminal 3 with conductor 2 of substrate 1, is fixed by adhesive 5 in which the liquid resin is used. Accordingly, terminal 3 and conductor 2 can be positively electrically continued to each other over a long period of time. When terminal 3 is attached to substrate 1 by using double-sided adhesive tape 4, a contact pressure is immediately generated in the substrate contact portion and this state can be maintained. Therefore, the following advantage can be provided. Even when a means such as a room-temperature-curing-type-resin, the curing time of which is somewhat long, is used, the process can proceed to the next step without waiting for the completion of the curing of the resin. In this connection, the terminal can be held with respect to the substrate by using a jig instead of the double-sided adhesive tape. However, it takes time and labor to attach and detach the jig. Therefore, it is desirable to use the double-sided adhesive tape, the work of which is easy. An instantaneous adhesive agent may be used instead of the double-sided adhesive tape.

Thickness of double-sided adhesive tape 4 is appropriately determined in accordance with the shape of terminal 3. When tape 4 is too thick, an appropriate contacting force is not generated between substrate contact portion 33 of terminal 3 and conductor 2 on substrate 1, that is, between the protruding portion and conductor 2 on substrate 1. When tape 4 is too thin, the contacting force concerned becomes too strong and there is a possibility that tape 4 is peeled off from terminal 3 or substrate 1. However, as described above, since the protruding portion and the conductor on the substrate are strongly fixed to each other by the epoxy adhesive, it is sufficient that the double-sided adhesive tape fulfills a function of a temporarily fixing member capable of exhibiting a fixing function until the adhesive is cured. In general, the double-sided adhesive tape can be easily handled, however, it is not suitable for supporting a heavy load over a long period of time. For the above reasons, the double-sided adhesive tape can be effectively used while the characteristic of the tape is being put into practical use.

In the case where a joining means such as a double-sided adhesive tape 4, which has an insulating property, is used, when another conductor (not shown) electrically independent from conductor 2 is provided, even if the joining means is arranged being put on another conductor, conductor 2 and another conductor are not short-circuited to each other. Accordingly, this structure can be easily applied to a highly dense wiring portion. Concerning the double-sided adhesive tape, it is possible to utilize a commonly used inexpensive tape. On the other hand, in the case where it is unnecessary to pay attention to the short-circuit with another conductor, a conductive joining means can be used. In this case, fixing portion 31 of terminal 3 also acts as an electrically continuing passage to conductor 2. As a result, it is possible to increase the electrically continuing passage of the terminal.

When substrate contact portion 33 of terminal 3 is formed into a protruding shape, a high contact pressure is generated in substrate contact portion 33. Therefore, even if a wiping effect is not provided by sliding, it is possible to attain an electrical connection by breaking through an oxide film on conductor 2. Since little or no wiping effect is provided, a surface of the substrate, which is generally made of glass, is seldom damaged.

Since substrate 1 is not necessarily a plane, it is preferable that a plurality of substrate contact portions 33 are provided as shown in FIG. 1. When the plurality of substrate contact portions 33 are provided, it is possible to reduce an intensity of electric current per one substrate contact portion and heat generation can be suppressed. When elastic portion 32 is formed into a comb-shape as shown in FIG. 1 and opening portions like slits are provided between the elastic portions, substrate contact portion 33 can be easily embedded in liquid resin 5 and more positively fixed to the substrate. Since each elastic portion is displaced according to the radius of curvature of substrate 1, each substrate contact portion can be positively electrically connected to the substrate. In this connection, instead of the slit shape or in addition to the slit shape, holes may be formed around the substrate contact portion by punching.

Terminal 3 shown in FIG. 1 is formed into a beam, both end portions of which are supported, in which elastic portions 32 is formed between two fixing portions 31. However, it is possible that terminal 3 is formed into a cantilever in which the elastic portion extends from one fixing portion. This cantilever structure is suitably used in the case where a mounting space of the terminal is restricted or it is wanted to downsize the entire structure. When necessary, it is possible to employ such a structure that elastic portions are extended in two or more directions from one fixing portion. Alternatively, it is possible to employ such a structure as another embodiment that a plurality of fixing portions and a plurality of elastic portions are alternately arranged.

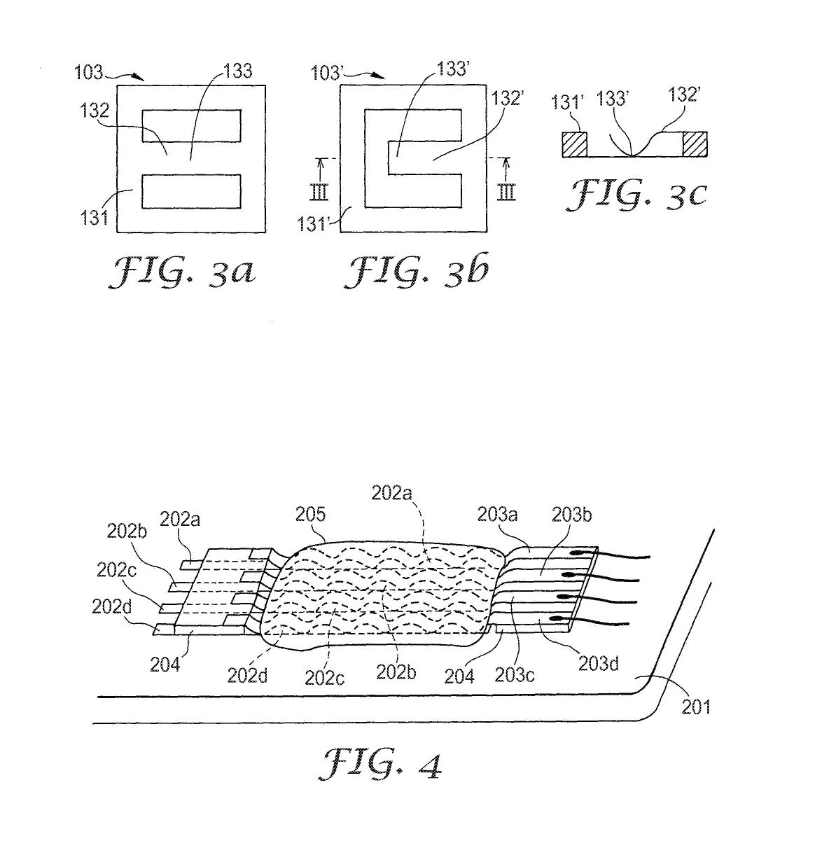

FIG. 3(a) is a plan view showing an outline of a terminal 103 of a second embodiment. As shown in the drawing, a fixing portion 131 of terminal 103 is formed into a frame-shape and an elastic portion 132 is arranged inside a frame portion 131. In this case, fixing portion 131 acts as a frame portion for surrounding a substrate contact portion 133. Therefore, when liquid resin is poured, it is prevented from flowing outside the fixing portion. Accordingly, masking is not required in this structure.

FIGS. 3(b) and (c) are views showing a terminal 103′ which is a variation of the terminal shown in FIG. 3(a). Elastic portion 132 shown in FIG. 3(a) is formed into a beam, both end portions of which are supported. On the other hand, an elastic portion 132′ of terminal 103′ is formed into a cantilever-shape, at the forward end portion of which a substrate contact portion 133′ is provided. Even in this embodiment, it is possible to prevent the liquid resin from flowing outside a fixing portion 131′.

FIG. 4 is a perspective view showing a third embodiment. In the third embodiment, a conductor provided on a substrate 201 is divided into four conductors 202a to 202d which are electrically independent from each other and the terminal provided on substrate 201 is divided into four terminals 203a to 203d which are electrically independent from each other. Terminals 203a to 203d are respectively separately connected and continued to conductors 202a to 202d. In this connection, concerning the connection of each conductor with each terminal, the conductor and the terminal can be connected with each other by using a double-sided adhesive tape 204 and liquid resin 205 in the same manner as that shown FIG. 1. Therefore, the detailed explanations are omitted here. When the conductors and the terminals are made to be electrically independent from each other as described above, different currents and signals can be sent through the conductors and the terminals.

In the embodiment as shown in FIG. 1 or 4, the elastic portion is arranged between the two fixing portions and the substrate contact portion provided on the elastic portion is adhered to the substrate by the liquid resin or the like. However, the coefficient of thermal expansion of the adhesive such as liquid resin is significantly different from that of the substrate such as a glass. Therefore, when the constitution as shown in FIG. 1 or 4 is used under the condition of high temperature, the substrate contact portion embedded in the adhesive may be separated from the substrate due to the thermal expansion of the terminal. Therefore, in a fourth embodiment as described below, the substrate contact portion is formed as a free end in order to reduce the influence due to the thermal expansion.

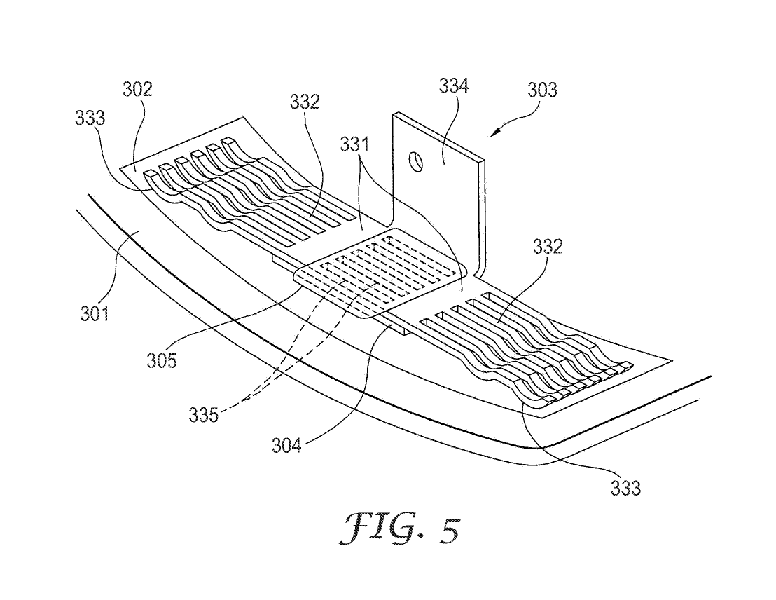

FIG. 5 is a perspective view showing the fourth embodiment of the terminal mounting structure of the present invention. As shown in the drawing, a terminal 303 is connected and continued to a conductor 302 such as a heating wire which is formed on a substrate 301 such as a rear window of an automobile. Terminal 303 includes: a fixing portions 331; a plurality of elastic portions 332 extending from fixing portion 331 in the different direction (the opposing directions in the embodiment); and substrate contact portions 333 provided in elastic portions 332 so that substrate contact portions 333 can be protruded with respect to substrate 301, and electrically connected to conductor 302. Fixing portion 331 is formed into a substantially flat plate shape and a surface of fixing portion 331 on the substrate side is made to adhere to substrate 301 by a joining means such as a double-sided adhesive tape 304. Fixing portion 331 of terminal 303 is made to adhere to substrate 301 by adhesive 305 under the condition that substrate contact portion 333 comes into contact with conductor 302 by the repulsive force generated by an elastic displacement of elastic portion 332. In this connection, the part of fixing portion 331 adhered to substrate 301 by adhesive 305 may be other than a part of fixing portion 331 adhered to substrate 301 by the joining means.

Terminal 303 includes a cable connecting portion 334 to be connected to a power supply cable not shown. Cable connecting portion 334 is arranged being vertically extended from fixing portion 331 in a direction in which cable connecting portion 334 is separate from substrate 301. A connector (not shown) attached to the power supply cable can be connected to cable connecting portion 334. When necessary, a housing (not shown) made of resin may be attached to cable connecting portion 334. An electric current sent from the power supply cable can flow from cable connecting portion 334 of terminal 303 to conductor 302 on substrate 301 through substrate contact portion 333.

A method of attaching terminal 303 to substrate 301 may be generally similar to that explained using FIGS. 2(a) to (c), except that the liquid resin is poured on fixing portion 331. Therefore, the detailed explanations are omitted here.

In the fourth embodiment as shown in FIG. 5, substrate contact portion 333 is formed as a free end which is not fixed to the substrate. Therefore, when terminal 303 is expanded or contracted due to fluctuation in external temperature or the like, substrate contact portion 333 may slide on conductor 302. Due to this, a disadvantageous stress cannot be applied to the terminal or the substrate such as glass, whereby the stable electrical connection may be maintained.

In the fourth embodiment, when substrate 301 is formed to have a concave surface as shown in FIG. 5, the contact pressure of the substrate contact portion against the substrate is larger than the case when the substrate is flat. Therefore, the fourth embodiment is particularly suitable for being applied to the inner surface of a rear window of a car.

When opening portions 335 like slits are formed in fixing portion 331, as shown in FIG. 5, fixing portion 331 can be easily embedded in liquid resin 305 and more positively fixed to the substrate. In this connection, instead of the slit shape or in addition to the slit shape, holes may be formed around the substrate contact portion by punching.

In the fourth embodiment, when foreign matter enters between substrate contact portion 333 and conductor 302 or when substrate contact portion 333 is deteriorated by being exposed to the air, the desired electrical connection between substrate contact portion 333 and conductor 302 may not be maintained. In order to avoid such a case, it is preferable that substrate contact portion 333 is sealed by means of elastic resin (not shown). As the elastic resin for sealing, silicon resin, epoxy resin, urethane resin, acryl resin or olefin hot-melt resin may be used.

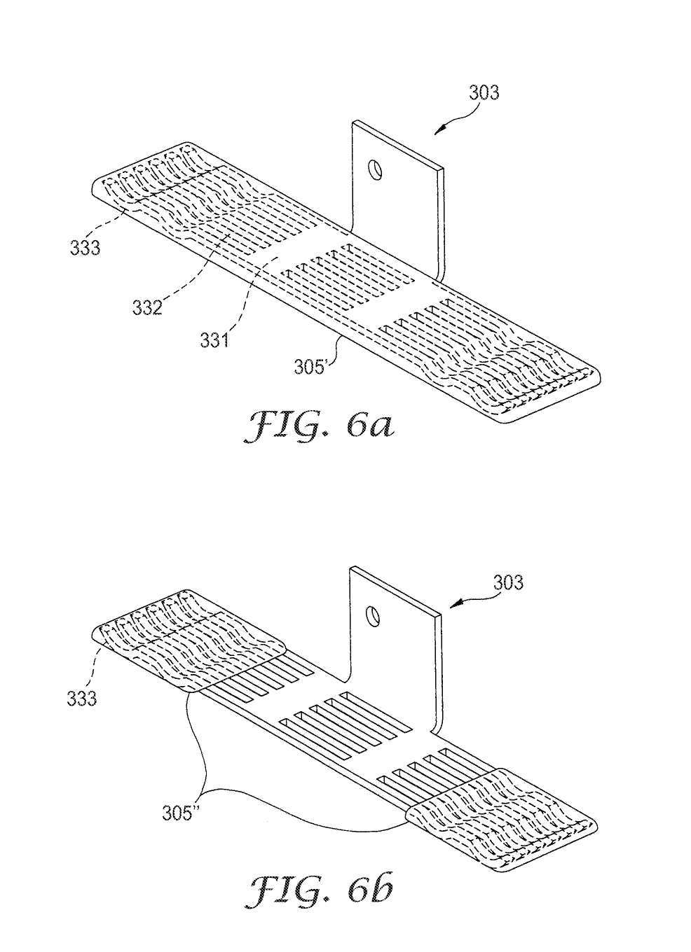

In the embodiment of FIG. 5, although only fixing portion 331 of terminal 303 is fixed to the substrate by adhesive such as resin, the other portion may be fixed. For example, as shown in FIG. 6(a), the portions of terminal 303 facing the substrate, i.e., all of fixing portion 331, elastic portion 332 and substrate contact portion 333 may be fixed by adhesive 305′ such as liquid resin. This embodiment is suitable for use in environments in which heat expansion is not an issue. Alternatively, as shown in FIG. 6(b), only substrate contact portion 333 may be fixed by adhesive 305″ such as liquid resin.

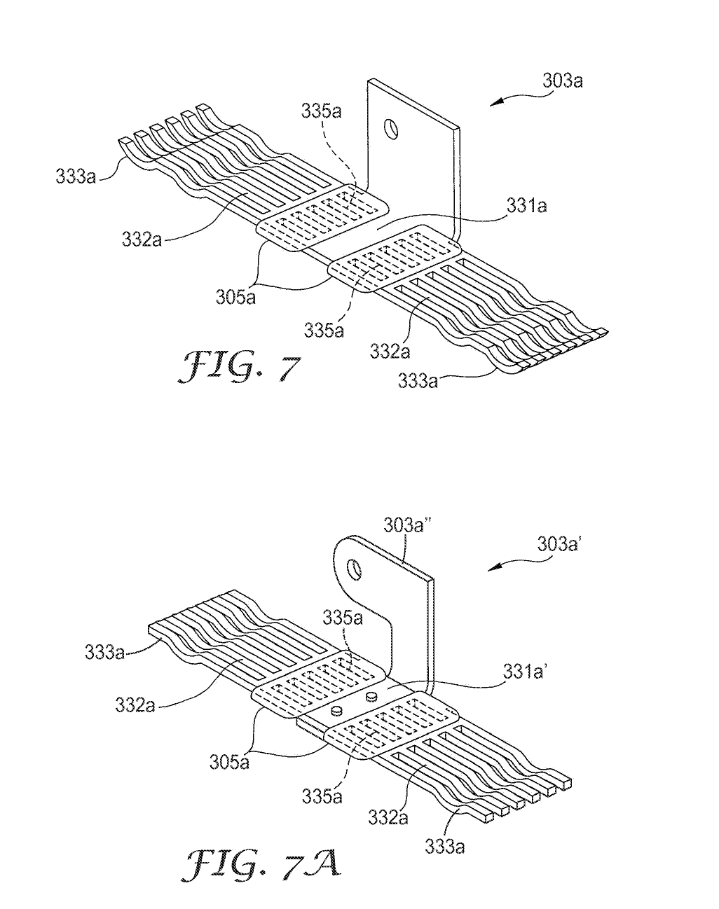

FIG. 7 shows a modification of the terminal of FIG. 5. In terminal 303 as shown in FIG. 5, slits 335 are formed between two fixing portions 331 (in other words, each fixing portion is positioned between the slits and the elastic portion). However, in a terminal 303a as shown in FIG. 7, slits 335a formed on two sites on both sides of one fixing portion 331a. In the embodiment of FIG. 5, the operation for pouring adhesive 305 such as liquid resin may be carried out only one time. On the other hand, in the embodiment of FIG. 7, the operation for pouring adhesive 305a such as liquid resin must be carried out twice. However, in the embodiment of FIG. 7, the fixed side of an elastic portion 332a may be supported by a part firmly fixed by adhesive 305a, whereby the contacting condition between substrate contact portion 333a and the substrate (not shown) is not affected by the deterioration of the joining means such as a double-sided adhesive tape. In addition, terminal 303a of FIG. 7 is also suitable for being applied to the inner surface of a rear window of a car.

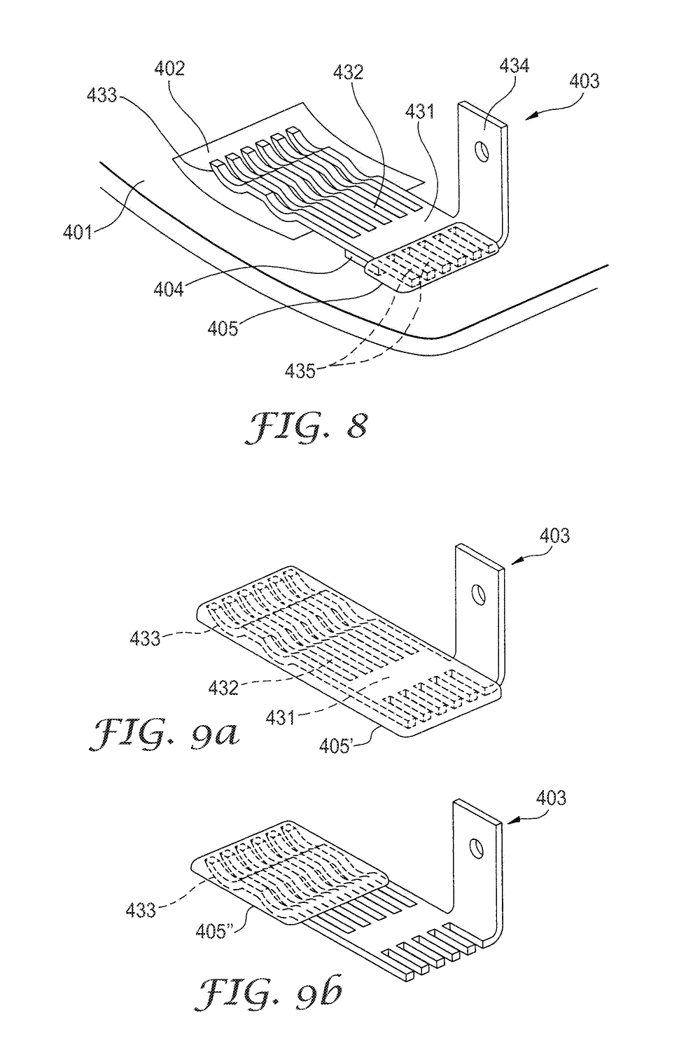

FIG. 7(a) is an example of a different type of embodiment of the terminals of the present invention. In the embodiment of FIG. 7(a), terminal 303a′ is constructed of two separate parts that are fastened together. FIG. 7(a) shows the parts fastened together with a screw or bolt, but any suitable fastening means would be acceptable. Terminal portion 303a″ is separate from the remainder of terminal 303a′ and is mechanically attached to fixing portion 331a′. In FIG. 7(a), the base of terminal portion 303a″ is attached to the underside of fixing portion 331a′. The two piece structure enables more flexibility in designing terminal 303a′ while maintaining the desired function of the contacts and other sections of terminal 303a′. As a result, the shape and orientation of the terminal portion 303a″ can be designed according to its intended application and use and different terminal portions 303a″ can be used with the same fixing/elastic/contact portion. Design and manufacture of the fixing/elastic/contact portion may also be made easier because it no longer needs to meet the thickness and other requirements of the terminal portion. This can allow for more design choices and can also allow for a thinner fixing/elastic/contact portion, which can be more physically flexible. The ability to make the contacts more physically flexible also allows the contacts 333 to be made shorter as shown in FIG. 7(a) while still functioning in the same manner as a longer contact. FIG. 8 is a perspective view showing a fifth embodiment of the terminal mounting structure of the present invention. A terminal 403 of the fifth embodiment has the shape obtained by dividing terminal 303a of the fourth embodiment generally into halves in relation to the extending direction of the elastic portions thereof. Therefore, terminal 403 is suitable for being applied to a narrow space in comparison to the fourth embodiment. As shown in the drawing, terminal 403 is connected and continued to a conductor 402 such as a heating wire which is formed on a substrate 401 such as a rear window of an automobile. Terminal 403 includes: a fixing portions 431; an elastic portion 432 extending from fixing portion 331 in one direction; and a substrate contact portion 433 provided in elastic portions 432 so that substrate contact portions 433 can be protruded with respect to substrate 401, and electrically connected to conductor 402. Fixing portion 431 is formed into a substantially flat plate shape and a surface of fixing portion 431 on the substrate side is made to adhere to substrate 401 by a joining means such as a double-sided adhesive tape 404. Fixing portion 431 of terminal 403 is made to adhere to substrate 401 by adhesive 405 under the condition that substrate contact portion 433 comes into contact with conductor 402 by the repulsive force generated by an elastic displacement of elastic portion 432. Terminal 403 includes a cable connecting portion 434 to be connected to a power supply cable not shown. Cable connecting portion 434 is arranged being vertically extended from fixing portion 431 in a direction in which cable connecting portion 434 is separate from substrate 401. A connector (not shown) attached to the power supply cable can be connected to cable connecting portion 434. When necessary, a housing (not shown) made of resin may be attached to cable connecting portion 434. An electric current sent from the power supply cable can flow from cable connecting portion 434 of terminal 403 to conductor 402 on substrate 401 through substrate contact portion 433.

A method of attaching terminal 403 to substrate 401 may be generally similar to that explained using FIGS. 2(a) to (c), except that the liquid resin is poured on fixing portion 431. Therefore, the detailed explanations are omitted here.

In the fifth embodiment as shown in FIG. 8, substrate contact portion 433 is formed as a free end which is not fixed to the substrate. Therefore, when terminal 403 is expanded or contracted due to fluctuation in external temperature or the like, substrate contact portion 433 may slide on conductor 402. Due to this, a disadvantageous stress cannot be applied to the terminal or the substrate such as glass, whereby the stable electrical connection may be maintained.

In the fifth embodiment, when substrate 401 is formed to have a concave surface as shown in FIG. 8, the contact pressure of the substrate contact portion against the substrate is larger than the case when the substrate is flat. Therefore, the fourth embodiment is particularly suitable for being applied to the inner surface of a rear window of a car.

When opening portions 435 like slits are formed in fixing portion 431, as shown in FIG. 8, fixing portion 431 can be easily embedded in liquid resin 405 and more positively fixed to the substrate. In this connection, instead of the slit shape or in addition to the slit shape, holes may be formed around the substrate contact portion by punching.

In the fifth embodiment, when foreign matter enters between substrate contact portion 433 and conductor 402 or when substrate contact portion 433 is deteriorated by being exposed to the air, the desired electrical connection between substrate contact portion 433 and conductor 402 may not be maintained. In order to avoid such a case, it is preferable that substrate contact portion 433 is sealed by means of elastic resin (not shown) after terminal 403 is attached to substrate 401. As the elastic resin for sealing, silicon resin, epoxy resin, urethane resin, acryl resin or olefin hot-melt resin may be used.

In the embodiment of FIG. 8, although only fixing portion 431 of terminal 403 is fixed to the substrate by adhesive such as resin, the other portion may be fixed. For example, as shown in FIG. 9(a), the portions of terminal 403 facing the substrate, i.e., all of fixing portion 431, elastic portion 432 and substrate contact portion 433 may be fixed by adhesive 405′ such as liquid resin. Alternatively, as shown in FIG. 9(b), only substrate contact portion 433 may be fixed by adhesive 405″ such as liquid resin.

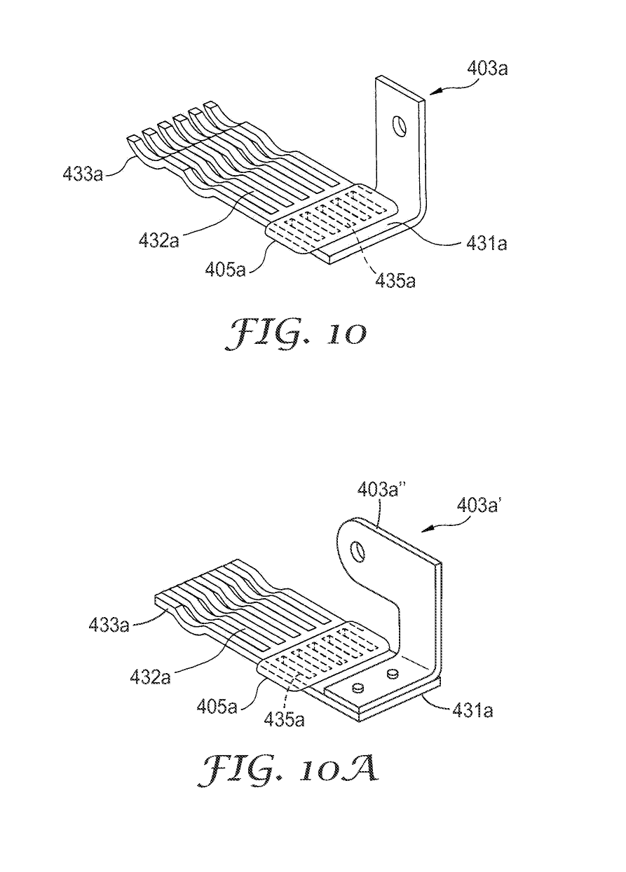

FIG. 10 shows a modification of the terminal of FIG. 8. In terminal 403 as shown in FIG. 8, fixing portion 431 is positioned between slits 435 and elastic portions 432. However, in a terminal 403a as shown in FIG. 10, slits 435a or adhesive 405a is positioned between fixing portion 431a and elastic portion 432a. In the embodiment of FIG. 8, the operation for pouring adhesive 405 such as liquid resin may be carried out only one time. On the other hand, in the embodiment of FIG. 10, the operation for pouring adhesive 305a such as liquid resin also may be carried only one time, and further, the fixed side of an elastic portion 432a may be supported by a part firmly fixed by adhesive 405a, whereby the contacting condition between substrate contact portion 433a and the substrate (not shown) is not affected by the deterioration of the joining means such as a double-sided adhesive tape. In addition, terminal 403a of FIG. 10 is also suitable for being applied to the inner surface of a rear window of a car.

Similar to FIG. 7(a), FIG. 10(a) is an example of a different type of embodiment of the terminals of the present invention. In the embodiment of FIG. 10(a), terminal 303a′ is constructed of two separate parts that are fastened together. FIG. 10(a) shows the parts fastened together with a screw or bolt, but any suitable fastening means would be acceptable. Terminal portion 303a″ is separate from the remainder of terminal 303a′ and is mechanically attached to fixing portion 331a′. In FIG. 10(a), the base of terminal portion 303a″ is attached to the top side of fixing portion 331a′. The two piece structure enables more flexibility in designing terminal 303a′ while maintaining the desired function of the contacts and other sections of terminal 303a′. As a result, the shape and orientation of the terminal portion 303a″ can be designed according to its intended application and use and different terminal portions 303a″ can be used with the same fixing/elastic/contact portion. Design and manufacture of the fixing/elastic/contact portion may also be made easier because it no longer needs to meet the thickness and other requirements of the terminal portion. This can allow for more design choices and can also allow for a thinner fixing/elastic/contact portion, which can be more physically flexible. The ability to make the contacts more physically flexible also allows the contacts 333 to be made shorter as shown in FIG. 10(a) while still functioning in the same manner as a longer contact.

The present invention can be very effectively used for connecting a heating wire, which is used for defogging of a rear window of an automobile, to an electric power cable. This heating wire is usually formed in such a manner that a conductive paste is printed on a pane of glass and brazing is manually executed so as to connect the heating wire to the terminal. However, according to the present invention, the brazing work, which takes time and labor, can be replaced by a very simple adhesion step. Further, it is possible to obtain a reliable electrical continuation connection state.

The present invention can be applied to a case in which a connector is mounted on a printed wiring substrate. When the present invention is utilized, it is unnecessary to execute a so-called reflow step in which a connector is put on a substrate, on which solder is previously coated, and the solder is melted in a continuous furnace so that the connector can be joined to the printed wiring substrate. Accordingly, mounting of the connector can be executed without exposing the connector to a high temperature.

Further, according to the present invention, the terminal can be positively connected and continued to the conductor made of aluminum or conductive ceramics to which it is difficult for the terminal to be joined by means of brazing.

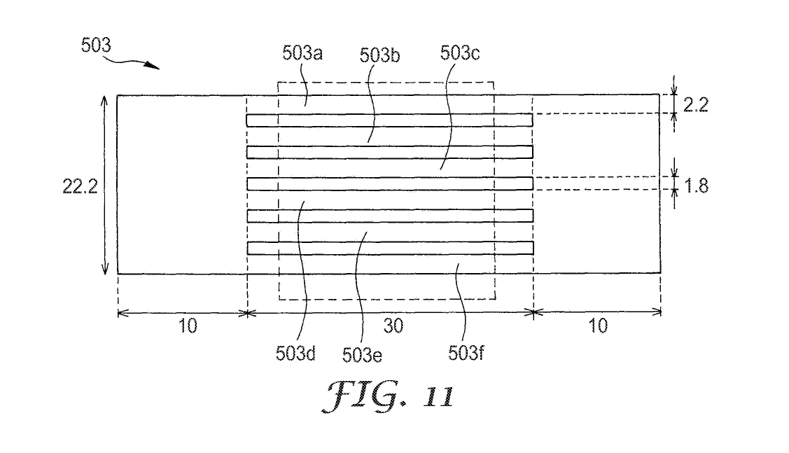

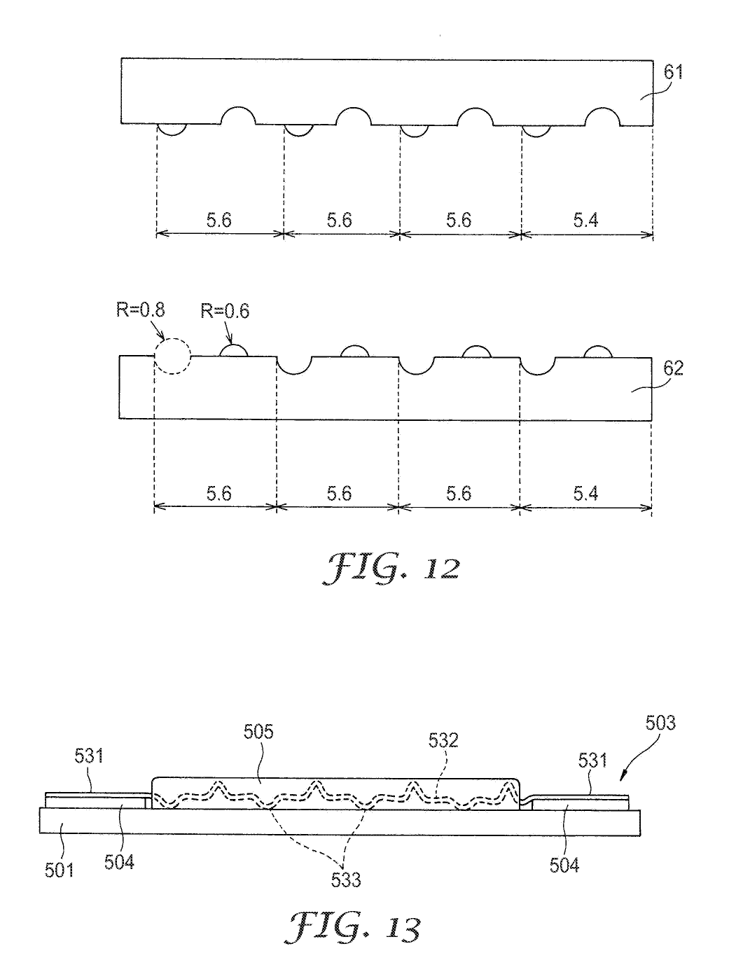

An embodiment of the terminal mounting structure of the present invention will be explained below. A plate made of brass of 0.5 mm thickness, the shape of which is shown in FIG. 11, was manufactured. In a portion of the brass plate surrounded by broken lines in FIG. 11, protruding shapes were formed by giving a load of about 3000N by using the metallic dies 61, 62 shown in FIG. 12. Due to the foregoing, it is possible to obtain a terminal 503 shown in FIG. 13 having a fixing portion 531, an elastic portion 532 and a protruding substrate contact portion 533. Next, both end portions of the brass plate were made to adhere to a copper plate 501 by using an adhesive tape 504 of 0.4 mm thickness. In this case, the adhesive tape was an acrylic form structural adhesive tape Y4920, the registered trade mark of which is VHB capable of being obtained from Sumitomo 3M Co., Ltd. In this way, the protruding portion 533 was contacted to the copper plate 501 with pressure. In this state, the base contacting portion 533 was sealed by two-liquid-curing-type epoxy resin 505 and cured at a room temperature. In this case, the two-liquid-curing-type epoxy resin was SCOTCH WELD EPX adhesive DP460 capable of being obtained from Sumitomo 3M Co., Ltd. After curing, in order to divide the terminal 503 into six terminals 503a to 503f, both ends of terminal 503 were cut off and a connection resistance of the copper plate with each terminal was measured by the four terminal method. The result of the measurement is shown on the following table 1.

TABLE 1

| Terminal | Connection resistance (Ω) |
|---|---|
| 503a | 0.0048 |
| 503b | 0.0017 |
| 503c | 0.0016 |
| 503d | 0.0013 |
| 503e | 0.0014 |
| 503f | 0.0056 |

1. A terminal mounting structure for mounting a terminal on a substrate, on the surface of which a conductor is provided,
the terminal includes: a fixing portion made to adhere to the substrate; an elastic portion extending from the fixing portion; and a substrate contact portion provided in the elastic portion, as a free end, distant from the fixing portion and electrically connected to the conductor on the substrate, wherein
the fixing portion of the terminal is attached to the substrate by a joining means, and
the fixing portion of the terminal is made to adhere to the substrate by adhesive under the condition that the substrate contact portion of the terminal is brought into contact with the conductor by the elastic displacement of the elastic portion.

2. A terminal mounting structure according to claim 1, wherein the substrate contact portion has a protruding portion which is bent into a protruding shape, and a top portion of the protruding portion is an electrical contact portion to be contacted with the conductor on the substrate.

3. A terminal mounting structure according to claim 1, wherein one or more through-holes are provided in at least one of the fixing portion and the elastic portion.

4. A terminal mounting structure for mounting a terminal on a substrate, on the surface of which a conductor is provided,
the terminal includes: a fixing portion made to adhere to the substrate; an elastic portion extending from the fixing portion; and a substrate contact portion provided in the elastic portion distant from the fixing portion and electrically connected to the conductor on the substrate, wherein
the fixing portion of the terminal is attached to the substrate by a joining means, and
the substrate contact portion of the terminal is made to adhere to the substrate by adhesive under the condition that the substrate contact portion of the terminal is brought into contact with the conductor by the elastic displacement of the elastic portion.

5. A terminal mounting structure according to claim 1, wherein the substrate contact portion has a protruding portion which is bent into a protruding shape, and a top portion of the protruding portion is an electrical contact portion to be contacted with the conductor on the substrate.

6. A terminal mounting structure according to claim 4, wherein one or more through-holes are provided in at least one of the substrate contact portion and the elastic portion.

7. A terminal mounting structure according to claim 4, wherein a frame portion is provided being connected to the fixing portion, the elastic portion is extended in a region defined by the fixing portion and the frame portion, and a double-sided adhesive tape is attached to a substrate face side of the frame portion and the fixing portion.

8. A terminal mounting structure according to claim 7, wherein an elastic portion extending from the frame portion is further provided in the region defined by the fixing portion and the frame portion.

9. A window for an automobile including a terminal mounting structure according to claim 1.

10. A terminal mounting method comprising the steps of:
forming a conductor on a surface of a substrate;
arranging a terminal on the substrate, the terminal having a fixing portion, an elastic portion extending from the fixing portion and a substrate contact portion provided in a portion of the elastic portion distant from the fixing portion and electrically connected to the conductor on the substrate;
attaching the fixing portion of the terminal to the substrate by a joining means; and
making the substrate contact portion of the terminal adhere to the substrate by adhesive under the condition that the substrate contact portion comes into contact with the conductor by the repulsive force generated by an elastic displacement of the elastic portion.

11. A terminal mounting method comprising the steps of:
forming a conductor on a surface of a substrate;
arranging a terminal on the substrate, the terminal having a fixing portion, an elastic portion extending from the fixing portion and a substrate contact portion provided in a portion of the elastic portion, as a free end, distant from the fixing portion and electrically connected to the conductor on the substrate;
attaching the fixing portion of the terminal to the substrate by a joining means; and
making the fixing portion of the terminal adhere to the substrate by adhesive under the condition that the substrate contact portion comes into contact with the conductor by the repulsive force generated by an elastic displacement of the elastic portion.
